(19) United States
(12) Patent Application Publication
(10) Pub. No.: US 2010/0015940 A1
(43) Pub. Date: Jan. 21, 2010

(54) RADIO RECEIVER

(76) Inventors: Jens Passoke, Hemmingen (DE); Gerhard Kottschlag, Hildesheim (DE)

Correspondence Address: KENYON & KENYON LLP, ONE BROADWAY, NEW YORK, NY, 10004, US

(21) Appl. No.: 12/304,582

(22) PCT Filed: Aug. 10, 2007
(86) PCT No.: PCT/EP07/58319

§ 371 Date: May 15, 2009

(30) Foreign Application Priority Data
Sep. 25, 2006 (DE) 10 2006 045 160.0

(51) Int. Cl. H04B 1/26

(52) U.S. Cl. 455/318

(57) ABSTRACT

In a radio receiver, the receive signal is conditioned in parallel in at least two paths, in one path a first mixing oscillator signal lying above a channel center by an absolute value, and in a second path a second mixing oscillator signal lying below the channel center by an absolute value, and furthermore, special components are able to be filtered out using filters, and subsequently the signals are conditioned and/or combined in a suitable manner.

### FIELD OF THE INVENTION

The present invention relates to a radio receiver.

### BACKGROUND INFORMATION

In conventional radio receivers, various concepts are used to extract the desired radio signal from the reception spectrum. Various of the following concepts are widespread, particularly for receivers having digital signal processing.

The superheterodyne receiver having a high intermediate frequency (ZF) (e.g. JP 2006 174326). This concept has the advantage that it demonstrates robustness against interfering reception of the image frequency and, with respect to this, many filter types, filter frequencies and filter bandwidths are available. It is disadvantageous, however, that the relative bandwidth of the ZF filter has to be designed to be very narrow, and is therefore not able to be integrated into standard semiconductor processes, which then creates high component costs.

Also conventional is a superheterodyne receiver having a low intermediate frequency (e.g. DE 36 18 782 A1). It has the advantage that the ZF filter has a large relative bandwidth and it makes possible, with the low ZF frequency, an integration even in standard semiconductor processes, whereby component part costs may be lowered. A disadvantage in this is the sensibility with respect to strong signals at the image frequency, since useful frequency and image frequency are in the same frequency range, and filtering the mixer is barely possible.

Moreover, superheterodyne receivers having an intermediate frequency of 0 Hz are designated at times as Zero-IF concept and below also as direct superheterodyne receiver or direct mixing. These have the advantage that, concept-conditioned, no image frequency is present, and the ZF filter is able to be integrated as a low-pass filter in standard semiconductor processes. However, it is disadvantageous, in this instance, that signal components in the channel center are interfered with, since, in response to mixing, they would fall into frequency 0 Hz, and as direct voltage would be supplied to the subsequent stage. The direct voltage correction measures frequently required in these concepts impair all lower ZF frequency components, and thus prevent the undistorted processing of such spectral components of the receiving signal which are transmitted close to the channel center frequency.

### SUMMARY

Example embodiments of the present invention provide a radio receiver which is less susceptible to interference signals and is able to be constructed as simply as possible and as cost-effectively as possible.

Example embodiments of the present invention provide a radio receiver in which the receive signal is conditioned in parallel in at least two paths, in one path, a first mixing oscillator signal lying above the channel center by an absolute value, and in a second path, a second mixing oscillator signal lying below the channel center by an absolute value, and furthermore, using filters, spectral components may be filtered out, and subsequently, the signals are conditioned in a suitable manner and/or are combined. This concept will be denoted below as segmented mixture or segmenting superheterodyne receiver.

It is advantageous, in this context, if furthermore the signal components of the output signals of the mixers and signals derived therefrom are able to be digitized using analog/digital converters.

It is also expedient if the individual stages, such as mixer, analog/digital converter and/or filter are able to be integrated into a semiconductor. This will advantageously create a cost-effective implementation.

It is particularly expedient if the conditioning of the signals takes place in at least two paths. A preferably contemporaneous conditioning is able to take place thereby.

It is also expedient if the conditioning of several signals takes place in only one or at least one path in a time multiplex. Correspondingly, it is advantageous if the analog/digital conversion takes place time-staggered in the time-division multiplex.

Furthermore, it is advantageous if a frequency shift of the mixing oscillator and/or the filter corner frequencies of the band-passes at the mixer outputs are variable as a function of the channel raster, of the actual signal bandwidth and/or the (interfering) signals in the neighboring channels.

It is also expedient if, for generating the two oscillator frequencies, two separate voltage-controlled oscillators (VCO) are used, which are connected preferably by two phase-coupled feedback control circuits (PLL) to a common reference frequency.

In an exemplary embodiment of the present invention, it is expedient if, for generating the two oscillator frequencies, one voltage-controlled oscillator (VCO) is operated at one of the two mixer control frequencies or a multiple thereof, and the second mixer control frequency is gathered by mixing this signal with 2*Δ, or rather 2n*66 in the case where the partitioning of the oscillator signals takes place before their subdividing using a dividing factor n to the mixer control frequencies.

Beyond that, it is advantageous, especially at low receiving frequencies, first to mix the receiving signals to an intermediate frequency, preferably far above the receiving frequency, and only then to submit it in additional conditioning stages to segmented mixing in the manner according to example embodiments of the present invention. In doing so, it may be of advantage to carry out the first mixing process using a variable frequency, which is generated, for example, by a VCO, however, not to carry out the second mixing process using an additional VCO but using a fixed second mixing frequency.

Advantageous further developments are indicated below.

The present invention is explained below in greater detail, based on an exemplary embodiment and with the aid of the drawings.

### BRIEF DESCRIPTION OF THE DRAWINGS

FIG. 1 is a schematic representation of received signals and interfering signals for various receiving concepts; and

FIG. 2 is a schematic representation of a radio receiver according to an example embodiment of the present invention.

### DETAILED DESCRIPTION

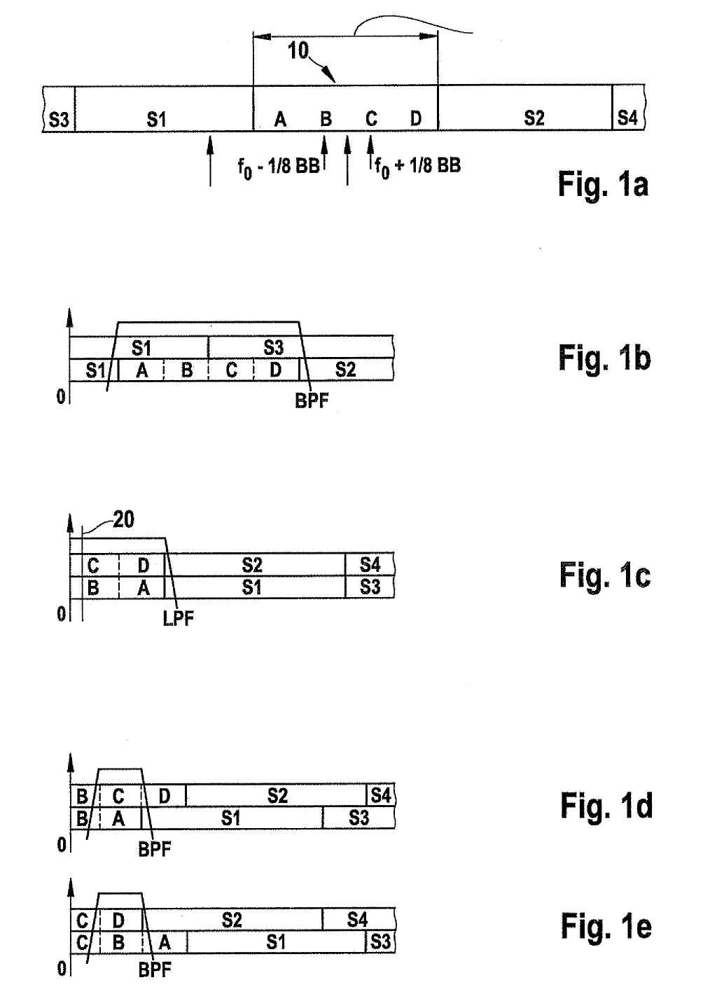

FIG. 1 and subfigures 1a to 1e show schematically two conventional reception concepts and the reception arrangement according to an example embodiment of the present invention.

The composition of the reception signal is sketched illustratively in FIG. 1a. In this context, a useful signal 10 of channel bandwidth BB is flanked by a plurality of interference signals S1, S2, S3, S4. The subdivision A, B, C, D in the useful signal is used for the later explanation of the receiving mechanisms, and these blocks include, for instance, spectral components of a common useful signal.

FIG. 1b shows a representation of superheterodyne receivers having a low intermediate frequency. If a mixing oscillator is used in a superheterodyne receiver whose frequency is possibly clearly outside the receiving channel, the received signal is converted to another frequency range by the mixer process. The signals present at the image frequency are also transferred into the same frequency range. Since, at this point, no separation is any longer possible between useful signal and image frequency signal, the receiving capability at the image frequency has to be sufficiently suppressed ahead of time, by suitable measures, such as, for instance, by prefiltering, using a band-pass filter BPF, or by using an image frequency-suppressing mixer, which also increases the immunity to interference. To be sure, as a rule the suppression capability of such mixers is significantly limited by the properties of the technology used. In the case of concepts having low ZF for radio reception, both the measures described above, even in combination, show no sufficient immunity to interference so as to satisfy customer expectations that were impressed by the good interference behavior of classical receivers, at justifiable expenditure.

FIG. 1c shows a representation for the so-called direct superheterodyne receiver. If the receiving band is mixed with an oscillator signal in the center of the reception channel, one speaks of direct mixing or zero IF concept, that is, the average frequency of the ZF band drops to 0 Hz. Since positive and negative frequencies do not differ with respect to their frequency, signal components C and D fall above the oscillator frequency exactly on the signal components B and A, which lay in the reception channel below the oscillator frequency. When using an IQ mixer, which in a first mixer cell mixes the reception signal, on the one hand, with the mixing oscillator signal, and in the second mixer cell mixes the same reception signal with the mixing oscillator signal shifted by 90°, the two partial spectra obtained from the mixed products obtained from this may be obtained again below or above the oscillator frequency and combined to form the original useful signal. In principle, the direct superheterodyne receiver demonstrates the same image frequency problems as a superheterodyne receiver having a low intermediate frequency. To be sure, in this case the image band is a component of the user information channel (A and B are the images to D and C, and vice versa). Consequently, it is impossible that a high-stage interference signal is superposed on a weak useful signal, the image stage is always just as great as the unimaged signal component, and thus approximately 30 dB to 40 dB of stage suppression is sufficient as a rule, in this instance. Problematic in the direct superheterodyne receiver are the frequency ranges that lie close to the frequency 0 Hz indicated by parting line 20. These spectral components of blocks B and C, which originally lie in channel center of the useful signal, may be taken into account during further processing, for example, by circuit parts of the receiver which are intended to compensate a direct voltage shift by signal components in the channel center at the transition location between blocks B and C, or a temperature drift of the receiver stages.

FIGS. 1d and 1e show the conditions occurring in response to the segmented mixing according to example embodiments of the present invention, in this case segmented direct mixing. The radio receiver according to example embodiments of the present invention utilizes two IQ mixers with then altogether four mixer cells, so that the receive signal is mixed with four different oscillator signals. Two frequencies are used each having two phase positions shifted by 90°. In the example shown, the two are shifted by +⅛ and −⅛ of the bandwidth (BB) of the useful channel from the channel center frequency. The advantages are visible in the diagram: The IQ mixer controlled by the lower frequency signal, see FIG. 1d, is able to output segments A and C undisturbed, and they are extracted by a subsequent band-pass filter BPF. Block B is impaired by its frequency position near 0 Hz, and block D is interfered with possibly by a strong interference signal S1 at the image frequency.

Specifically, these missing blocks B and D are provided undisturbed by the other IQ mixer. In this instance, ranges A and C are affected by the disturbance scenarios described above.

Segments A, B, C and D should not be understood, in the practical execution of example embodiments of the present invention, as sharply delimited blocks, but may be processed slightly overlapping, using a suitable weighting function, as is indicated by the slanted filter sides in the diagram.

The radio receiver according to example embodiments of the present invention is based on a superheterodyne receiver or direct superheterodyne receiver, which is designed double or manifold in some stages and modified as described below. The receive signal is conditioned, as a rule, parallel in at least two paths, the mixing oscillator signal of the first path or the first mixing oscillator signal lying above the channel center by a suitable fixed absolute value, and the mixing oscillator signal of the second path or the second mixing oscillator signal lying below the channel center by the same fixed absolute value. Generally, the shift amounts to less than half the channel width, preferably about ⅛ the channel width. From the output signals of the two mixer stages, at least the spectral components, which would be impaired by DC correction measures, are filtered out, such as being removed, for instance, using a band-pass filter. This filtering preferably also removes additional spectral components which could be impaired by superposition of image frequency reception. The remaining signal components of the various paths are rejoined thereafter, and yield an undisturbed image of the complete signal spectrum in the receive channel. Before the composition of the signal components, the possibly filtered output signals of the mixers are preferably first digitized, so that the merging and possibly present filtering is able to take place in the digital part. When using only one path or part of a path, for instance, of a single analog/digital converter, the various signal components in the respective stages may be conditioned in a time multiplex operation.

In spite of the increased number of conditioning blocks, such as the doubling of the number of, for example, IQ mixers, band-pass filters, A/D converters, the radio receiver device according to example embodiments of the present invention is able to be cost-effective, since the stages required in standard semiconductor technologies are able to be integrated, and, if necessary, only inexpensive external components are needed in addition.

The generation of oscillator signals f₀+Δ and f₀−Δ may take place preferably using a single voltage-controlled oscillator VCO that is, for example, connected to a phase-coupled feedback control circuit. From the VCO, a mixer control signal is generated directly or by division at the useful channel center frequency which is mixed in an IQ mixer at an offset frequency A (preferably Δ=⅛*BB). The two mixer control signals f₀+Δ and f₀−Δ are present at the outputs of a summing stage or subtracting stage of the mixer. The two signals offset by 90°, which are required in addition for the control of the mixer cells in the signal path, are derived from these signals.

The radio receiver according to example embodiments of the present invention has the advantage that all essential subassemblies in standard semiconductor technologies are able to be integrated. This allows one to avoid costly external filters in some instances.

Besides that, it may preferably be the case that no receive interferences because of DC effects and DC compensation circuits occur, since spectral components that would be affected by this may be discarded and substituted by the signal of the other path. In addition, 1/f noise is reduced, since the lowest-frequency signal components of the base band, that are most affected, are filtered out as described, and therefore no longer go into the output signal.

It is also advantageous that no interferences occur because of image frequency reception, since only such signal components are used whose image frequency lies in the useful channel.

It is also advantageous that the mixer cell in the oscillator path does indeed produce weak interference signals at input frequency and the respectively not desired mixer frequency, but the frequency position of these signals makes sure that, because of this, no powerful interference signals from neighboring channels are mixed into the useful channel.

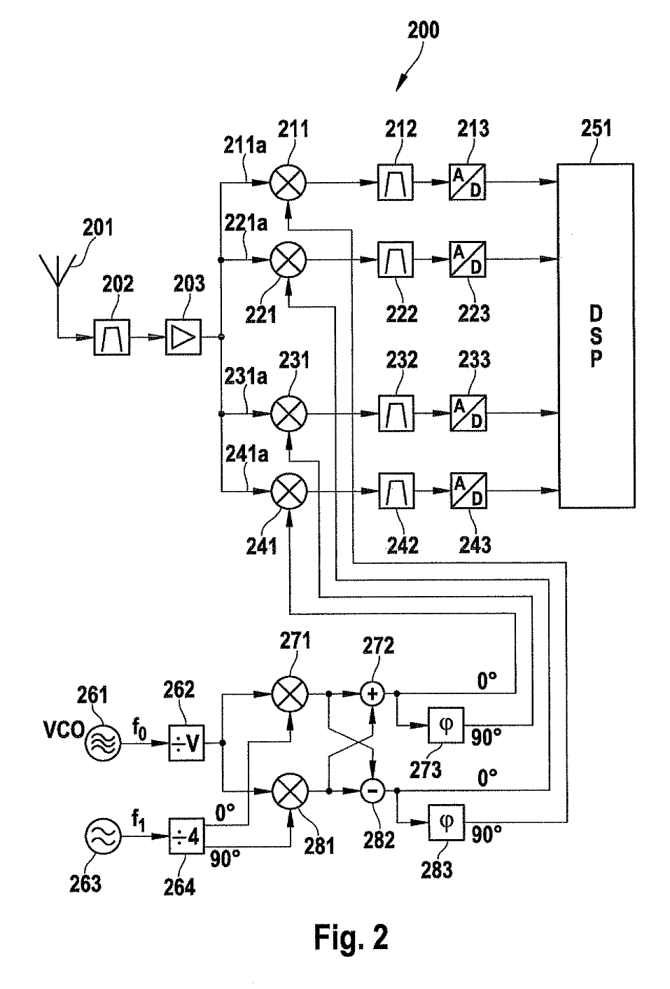

FIG. 2 shows a schematic block diagram of a radio receiver 200 according to example embodiments of the present invention. The receive signal of an antenna 201 is filtered using a postconnected filter 202 and amplified using amplifier 203 that is, in turn, postconnected, it is conducted to inputs 211a, 221a, 231a and 241a of four mixer cells 211, 221, 231, 241. The output signals of mixers 211, 221, 231, 241 are preferably band-pass filtered using postconnected filters 212, 222, 232, 242, are digitized using analog/digital converters 213, 223, 233, 243 and are supplied to a digital signal processor DSP 251. In digital signal processor 251, the four conditioned signals of the mixers are combined in a suitable manner and are thereafter demodulated in a known manner and processed further.

The mixer control signals for mixer cells 211, 221, 231, 241 are generated from a voltage-controlled oscillator VCO 261 and an additional oscillator 263. Voltage-controlled oscillator VCO 261 is controlled by a phase-coupled feedback control circuit (PLL), that is not shown, according to the related art. Second oscillator 263 supplies signal f₁ that is of lower frequency compared to that, as the output signal f₀ of voltage-controlled oscillator VCO 261. Instead of second oscillator 263, if necessary, a subdivided reference signal of the receive system may also be fed in, the dividing factor being able to be variable. This is particularly advantageous in order to be able to set and tune a suitable frequency offset. The frequency of this signal is yielded by the desired frequency offset A between the mixer control signal of an IQ mixer path and the channel center frequency, e.g. ⅛*BB, BE being equal to the bandwidth of the receive channel, and the division ratios in the signal chain between the oscillator and the mixer cells.

The voltage divider comes in in FIG. 2, so that in this case f1=4*Δ is the result. Divider 264 makes possible in a known way the generation of two output signals having a phase shift of 90°, these signals control two mixer cells 271, 281 in which the VCO signal f₀, divided by divider V (see block 262) is offset by ±Δ. By the control offset by 90° of the two mixer cells 271, 281 it is achieved in a known manner that at the outputs of summing stage 272 and subtracting stage 282, at one output signal f₀/V−Δ is present and at the other output signal f₀/V+Δ is present. In phase shifters 273 and 283, the signals required for controlling mixer cells 211, 221, 231, 241 are generated with a 90° phase shift.

Alternatively, the phase-shifted signals may also be generated by additional divider stages, which may be similar to stage 264. The dividing factor should then be taken into account in the design of the oscillator chain.

In an exemplary embodiment, instead of parallel conditioning over many paths, conditioning is carried out in a single path in time multiplex. This may result, for example, in a lesser wiring expenditure.

Correspondingly, in a further exemplary embodiment, the analog/digital conversion is no longer carried out using four separate analog/digital converters, but using one analog/digital converter in time multiplex.

According to one additional refinement of example embodiments of the present invention, a frequency shift of the mixing oscillator and/or the filter corner frequencies of the band-passes at the mixer outputs are variable as a function of the channel raster, of the actual signal bandwidth and/or the (interfering) signals (for instance, stage and/or bandwidth) in the neighboring channels.

Furthermore, in an exemplary embodiment of the present invention, it is expedient if, for generating the two oscillator frequencies, two separate voltage-controlled oscillators (VCO) are used, which are connected preferably by two phase-coupled feedback control circuits (PLL) to a common reference frequency.

Also, for generating the two oscillator frequencies, a voltage-controlled oscillator VCO may be operated at one of the two mixer control frequencies or a multiple thereof, the derivation of the second mixer control frequency takes place, in this case, by mixing with 2*Δ and 2n*Δ upon division of the oscillator signals before their subdivision, by which, using dividing factor n, the mixer control frequencies are generated.

Moreover, in a further exemplary embodiment, the generation of the mixer control signals, offset by 90°, by divider stages at the outputs of summing stages and subtracting stages 272, 282 may be undertaken. The dividing ratio, in this context, may be selected to be so high that the interference components remaining at the outputs of stages 272, 292 are sufficiently lowered, and thereby a sufficient immunity to interference is able to be achieved.

It should be observed, especially in the case of low receive frequencies, that the harmonics of the mixing oscillator signal also contribute to the mixture and may lead to secondary receive locations on integral multiples of the receive frequency. In a further variant of an example embodiment according to the present invention this effect is counteracted in that the receive signal is first mixed, using a VCO, to a fixed intermediate frequency, preferably far above the receive frequency, and that there the undesired mixture products of the harmonics, as well as image frequency reception are able to be eliminated using simple filtering measures, and that only then the segmented mixing to 0 Hz, described above, takes place in further conditioning stages. The second mixing does not require a second frequency-changing oscillator corresponding to block 261, and since the intermediate frequency remains constant, an oscillator having a fixed output frequency may be used and mixed with the signal of oscillator 263, in a manner described before.

In addition, an adjustment of the oscillator-mixer may take place by measuring the interference carrier stage. The mixer inputs in the receive path are switched off, so that no receive signal is guided through the mixer stages. Now, at the mixer outputs, only the oscillator remnants and interference lines by image carrier and VCO-through-talk are present. The strength of these signals may be recorded and minimized by adjustment of the signal stages.

Moreover, according to example embodiments of the present invention, a compensation for the oscillator mixer unbalance may be carried out. The interference signals created by the remnants of the image carriers and/or VCO-through-talk are preferably eliminated in the digital part by addition in phase opposition.

1-11. (canceled)

12. A radio receiver, comprising:
a mixer stage; and
a mixing oscillator;
wherein a frequency of a first mixing oscillator signal lies above at least one of (a) a channel center of a receive frequency and (b) an intermediate frequency by an absolute value, and that of a second mixing oscillator signal lies below the channel center by an absolute value, and furthermore, spectral components are filterable by filters and subsequently additionally conditioned signals are combinable again.

13. The radio receiver according to claim 12, wherein at least some stages of a signal path are carried out in multiple fashion and in which a received signal is conditionable in parallel in the stages, using various mixing oscillator signals.

14. The radio receiver according to claim 12, wherein a received signal is conditioned using the various mixing oscillator signals in time multiplex.

15. The radio receiver according to claim 12, wherein at least one of (a) output signals of the mixers and (b) signals derived from them are digitizable by analog/digital converters.

16. The radio receiver according to claim 12, wherein individual stages are integrated into a semiconductor component.

17. The radio receiver according to claim 12, wherein an analog/digital conversion takes place time-staggered in time multiplex.

18. The radio receiver according to claim 12, wherein at least one of (a) a frequency shift of the mixing oscillator signals and (b) a filter corner frequencies of band-passes are variable at mixer outputs as a function of channel raster, of at least one of (a) an actual signal bandwidth and/(b) interfering signals in neighboring channels.

19. The radio receiver according to claim 12, wherein two mixing oscillator signals are obtained from mixing of two oscillators, one oscillator being operated at a channel center of at least one of (a) a receive frequency, (b) an intermediate frequency, and (c) an integer multiple of the frequencies.

20. The radio receiver according to claim 12, wherein, for generating two oscillator frequencies, two separate voltage-controlled oscillators are provided, which are connected by two phase-coupled feedback control circuits to a common reference frequency.

21. The radio receiver according to claim 12, wherein, for generating two oscillator frequencies by a voltage-controlled oscillator at at least one of (a) one of two mixer control frequencies and (b) a multiple thereof, a derivation of a second mixer control frequency takes place by mixing with 2*Δ and 2n*Δ upon division of oscillator signals before subdivision, using dividing factor n, to form the mixer control frequencies.

22. The radio receiver according to claim 12, wherein a receive signal is mixed beforehand to an intermediate frequency and is filtered.
